(19) United States
(12) Patent Application Publication
(10) Pub. No.: US 2009/0220718 A1
(43) Pub. Date: Sep. 3, 2009

(54) FUEL CONTAINER

(75) Inventors: Kouta Isoyama, Kurashiki-shi (JP); W. Ronald Rose, Winnie, TX (US); Robert Chvala, Huntington Woods, MI (US)

Correspondence Address: OBLON, SPIVAK, MCCLELLAND MAIER & NEUSTADT, P.C., 1940 DUKE STREET, ALEXANDRIA, VA, 22314, US

(73) Assignee: KURARAY CO. LTD., Kurashiki-shi (JP)

(21) Appl. No.: 12/040,238

(22) Filed: Feb. 29, 2008

(51) Int. Cl. B32B 27/08; B60K 15/03

(52) U.S. Cl. 428/36.7; 220/62.15; 206/524.3; 206/6

(57) ABSTRACT

Provided is a fuel container containing a biodiesel fuel comprising at least one fatty acid ester selected from the group consisting of fatty acid methyl esters and fatty acid ethyl esters, wherein the fuel container is made of a multilayer structure wherein layers of high density polyethylene (a) are located on both sides of a layer of an ethylene-vinyl alcohol copolymer (c) via layers of adhesive resin (b). This fuel container is excellent in barrier performance and brittle degradation resistance against biodiesel fuels.

### TECHNICAL FIELD

The present invention relates to a fuel container excellent in barrier properties and brittle degradation resistance against biodiesel fuels.

### BACKGROUND ART

As a plastic fuel container, a monolayer type made of polyethylene is widely used, but it has a drawback of relatively high fuel permeability. In gasoline engine cars, it is effective that forming the fuel container with a laminated material and controlling the permeation of the fuel by providing a gasoline barrier layer as a part of the layers of the laminated material. However, because diesel fuels are less permeable than gasoline, even fuel containers of monolayer type made of polyethylene have fuel permeabilities within the ranges of the environmental regulations of various countries.

On the other hand, from the viewpoint of saving fossil fuel consumption, in diesel engine cars, biodiesel fuels containing biologically-derived fatty acid esters are increasingly used worldwide.

While the fatty acid esters used for biodiesel fuels are prepared from vegetable oils, such as rapeseed oil, soybean oil and corn oil, and animal oils. Such vegetable oils and animal oils contain fatty acid glycerol esters as major ingredients. A fatty acid ester is synthesized by hydrolyzing a fatty acid glycerol ester to decompose into a glycerol and a fatty acid and then condensing the fatty acid with methanol or ethanol. The fatty acid ester is also synthesized by transesterification of a fatty acid glycerol ester with methanol or ethanol. Fuels containing a fatty acid methyl ester or fatty acid ethyl ester synthesized in such a way are general biodiesel fuels.

However, the inventors of the present invention found that biodiesel fuels derived from plants or animals contain significant amounts of unsaturated fatty acid esters and that brittle degradation is accelerated and impact resistance is decreased in conventional monolayer type fuel containers of monolayer type made of polyethylene if the unsaturated fatty acid esters are oxidized. While the fuel permeability of such conventional fuel containers is not problematic under current regulations, it is not sufficient against future strengthening of environmental controls.

U.S. Pat. No. 6,033,749 discloses a fuel container for gasoline containing oxygen-containing compounds, the container being made of a multilayer structure wherein a layer of a high density polyethylene (a) is disposed on each side of a layer of an ethylene-vinyl alcohol copolymer (c) via a layer of an adhesive resin (b), wherein the thickness ratio (I/O) is smaller than about 40/60, where I is the total thickness of the layers positioned inside the layer (c) of an ethylene-vinyl alcohol copolymer, and O is the total thickness of the layers positioned outside the layer (c), and the thickness ratio (A/B) satisfies the following formula (1):

0.005≦(A/B)≦0.13 (1)

wherein A is the thickness of the layer of ethylene-vinyl alcohol copolymer (c) and B is the total thickness of all layers.

However, the oxygen-containing compounds contained in the gasoline used in U.S. Pat. No. 6,033,749 are only methanol, ethanol and methyl tert-butyl ether (MTBE), and no description is made to fatty acid esters. Therefore, U.S. Pat. No. 6,033,749 does not disclose problems inherent in the case that a biodiesel fuel containing an unsaturated fatty acid ester is used.

### DISCLOSURE OF THE INVENTION

### Problem to be Solved by the Invention

In light of such situations, to provide a fuel container excellent in barrier performance and brittle degradation resistance is very significant. An object of the present invention is to provide a fuel container which has a high density polyethylene layer and an ethylene-vinyl alcohol copolymer (EVOH) layer and which is excellent in barrier performance and also excellent in resistance to brittle degradation caused by oxidation of unsaturated fatty acid esters in the surface of the container.

### Means for Solving the Problem

The above-mentioned object can be attained by providing a fuel container comprising a multilayer structure wherein a layers of high density polyethylene (a) are located on both sides of a layer of an ethylene-vinyl alcohol copolymer (c) via layers of adhesive resin (b), and a biodiesel fuel comprising at least one fatty acid ester selected from the group consisting of fatty acid methyl ester and fatty acid ethyl ester is contained therein.

The ethylene content of the ethylene-vinyl alcohol copolymer (c) is preferably 20 to 60 mol %, and more preferably 22 to 30 mol %. It is also preferable that the biodiesel fuel contain the fatty acid ester at a content of 1% by weight or more. It is also preferable that the thickness ratio (I/O) be smaller than 50/50, where I is the total thickness of the layers positioned inside the layer of the ethylene-vinyl alcohol copolymer (c), and O is the total thickness of the layers positioned outside the layer of the ethylene-vinyl alcohol copolymer (c), and the thickness ratio (A/B) satisfy the following formula (1):

0.005≦(A/B)≦0.13 (1)

wherein A is the thickness of the layer of ethylene-vinyl alcohol copolymer (c) and B is the total thickness of all layers.

### EFFECT OF THE INVENTION

The fuel container of the present invention is excellent in barrier performance and brittle degradation resistance against biodiesel fuels. Therefore, this renders the fuel container capable of contributing to solve environmental problems and greatly enhances the safety in practical use of the container.

### BEST MODE FOR CARRYING OUT THE INVENTION

The fuel container of the present invention has a structure in which layers of high density polyethylene (a) are positioned on both sides of a layer of an EVOH (c) as a core layer, via layers of adhesive resin (b).

In the present invention, the EVOH (c) is a product obtained by saponifying an ethylene-vinyl ester copolymer and the ethylene content thereof is preferably 20 to 60 mol %. If the ethylene content is less than 20 mol %, the melt formability is poor and the gasoline barrier properties under a high humidity condition may deteriorate. The ethylene content is more preferably 22 mol % or more. If the ethylene content is more than 60 mol %, the gasoline barrier properties will deteriorate. The ethylene content is more preferably 40 mol % or less, even more preferably 35 mol % or less, particularly preferably 30 mol % or less, and most preferably 25 mol % or less.

Generally, it is known that the smaller the ethylene content of an EVOH is, the more the impact resistance of the EVOH deteriorates. However, what is more serious for a fuel container containing a biodiesel fuel containing an unsaturated fatty acid ester is the deterioration of impact resistance due to brittle degradation of polyethylene caused by oxidation of the unsaturated fatty acid ester. Therefore, unlike fuel containers for containing other types of fuels, it is preferable to adjust the degree of saponification of the EVOH (c) to 30 mol % or less, or 25 mol % or less, which are a less than usual.

A typical example of the vinyl ester is vinyl acetate. It is possible to use other fatty acid vinyl esters, such as vinyl propionate and vinyl pivalate.

The EVOH (c) may contain additional comonomers unless the effect of the present invention is affected. Such comonomers are not particularly restricted. However, inclusion of a vinyl silane compound in an amount of 0.0002 to 0.2 mol % is effective in improvement in moldability or the like because the compatibility of melt viscosity with a base material resin in coextrusion is improved, it is possible to produce uniform coextrued multilayer films, and moreover the dispersibility in use of EVOHs in blending is also improved. Examples of the vinyl silane compound include vinyltrimethoxysilane, vinyltriethoxysilane, vinyltri(β-methoxyethoxy)silane, and 3-(trimethoxysilyl)propyl methacrylate. In particular, vinyltrimethoxysilane and vinyltriethoxysilane can be preferably used. It is also possible to copolymerize other comonomers, e.g. propylene, butylene, unsaturated carboxylic acids or esters thereof (such as (meth)acrylic acid and (meth)acrylates) and vinyl pyrrolidone (such as N-vinylpyrrolidone).

The EVOH (c) used in the present invention preferably has a melt index (MI) within the range of 0.1 to 50 g/10 min, more preferably 0.5 to 20 g/10 min, at 190° C. under a load of 2160 g. For samples having a melting point near or over 190° C., measurements are conducted at temperatures of the melting point or higher under a load of 2160 g, and a melt index is determined by extrapolating the measured values to 190° C. on a semilogarithmic graph with the reciprocal of the absolute temperature on the abscissa and the MI (logarithm) on the ordinate.

In some cases in the present invention, it is more preferable to use the EVOH (c) in combination with one or more EVOHs differing in ethylene content and/or degree of saponification from the EVOH (c).

In the present invention, the layer of the EVOH (c) is originally a layer made of an EVOH resin alone; however, other resins may be incorporated unless the effect of the present invention is affected. Examples of such resins include polyolefin resins, polystyrene, polyamide resins, saturated polyester resins (such as polyethylene terephthalate), polycarbonate resins, polyvinyl chloride resins, and polyvinylidene chloride resins. In particular, examples of preferable resins include ethylene-acrylic acid ester-maleic anhydride terpolymers and modified polyolefins such as polyolefins having at least one functional group selected from a boronic acid group, a borinic acid group, and a boron-containing group convertible into a boronic acid group or a borinic acid group in the presence of water. It should be noted that the amount of the blending resin should be limited in consideration of gasoline barrier properties and melt stability.

In the present invention, the high density polyethylene (a) is a polymer which is obtained by a low-pressure process or medium-pressure process where a Ziegler catalyst is used, for example, and which has a density of 0.93 g/cm³ or more, and preferably 0.94 g/cm³ or more. If a polyethylene having a density lower than 0.93 g/cm³ is used, the product can not be used as a fuel container due to lack barrier property and stiffness. The high density polyethylene (a) preferably has a melt index (MI), as measured at 190° C. under a load of 2160 g, of 0.001 to 0.6 g/10 min, and more preferably 0.005 to 0.1 g/10 min.

In the layer of the high density polyethylene (a), other resins may be incorporated unless the effect of the present invention is affected. Examples of such resins include EVOH resin, polyolefin resin (other than the high density polyethylene (a)), polystyrene, polyamide resin, saturated polyester resin (such as polyethylene terephthalate), polycarbonate resin, polyvinyl chloride resin, and polyvinylidene chloride resin. It, however, is preferable that the high density polyethylene (a) be used as a major component and other resins be incorporated unless the effect of the present invention is affected.

Scraps recovered during forming process can be used as the layer of the high density polyethylene (a) if they are composed of high density polyethylene as a major component. Such recovered scraps include forming loss generated in the production of formed articles such as hollow containers, tubular containers and tubular products, or crushed chips of recovered scraps after use by general consumers. Use of such recovered scraps is preferable from the viewpoint of environmental preservation point because it will result in reduction in the amount of waste. It also leads to an effect of cost reduction. In this case, the layer of the high density polyethylene (a) may be formed of either recovered scraps only or a mixture of such recovered scraps and a high density polyethylene. Moreover, it is also permissible to adopt a layer of a high density polyethylene (a) composed of a multilayer structure containing a layer of only the high density polyethylene (a) and a layer containing recovered scraps.

While a recovered scrap component contains the high density polyethylene (a) as a major component, and typically contains the EVOH (c) and the adhesive resin (b), it is also permissible to add a compatibilizer or a stabilizer to the recovered scrap component for improvement in melt film-formability. Examples of such a compatibilizer and stabilizer include ethylene-acrylic acid ester-maleic anhydride terpolymers, resins having at least one functional group selected from a boronic acid group, a borinic acid group, and a boron-containing group convertible into a boronic acid group or a borinic acid group in the presence of water, metal salt of higher fatty acid, and hydrotalcite.

A fuel container which is excellent in fuel barrier properties and also excellent in impact resistance as shown infra in Examples can be obtained by laminating layers of such a high density polyethylene layer (a) on both sides of a layer of an EVOH (c) via layers of an adhesive resin (b). In preferable embodiments, the layers of the high density polyethylene layer (a) are located as the innermost layer and the outermost layer; however, a layer of another resin may be laminated as the innermost layer or the outermost layer unless the object of the present invention is impaired. The total thickness of the high density polyethylene (a) including the inner and outer layers thereof is preferably 300 to 10000 μm, more preferably 500 to 8000 μm, and most preferably 1000 to 6000 μm.

The adhesive resin (b) to be used for the layer of an adhesive resin (b) is not specifically restricted. It is permissible to use a modified polyolefin resin, a polyurethane resin, a one-component or two-component curable polyester resin, etc. In view of the adhesion to the EVOH (c) and the high density polyethylene (c) and the melt formability, a modified polyolefin resin is preferred, and a carboxylic acid-modified polyolefin resin is particularly preferred. The carboxylic acid-modified polyolefin resin can be obtained by copolymerization or graft modification of an olefin polymer or copolymer with an unsaturated carboxylic acid or anhydride thereof (such as maleic anhydride).

It is more preferable that the carboxylic acid-modified polyolefin resin be a carboxylic acid-modified polyethylene resin from the viewpoint of the adhesion with the high density polyethylene (a) and compatibility at the time of scrap recycling. Examples of such carboxylic acid-modified polyethylene include products resulting from carboxylic acid modification of polyethylene (such as low density polyethylene (LDPE), linear low density polyethylene (LLDPE), super low density polyethylene (SLDPE)), ethylene-vinyl acetate copolymer, and ethylene-(meth) acrylic acid ester (methyl ester or ethyl ester) copolymer.

By providing a layer of the adhesive resin (b) between a layer of the high density polyethylene (a) and a layer of the EVOH (c), it is possible to obtain a fuel container which has excellent interlayer adhesion properties and which is excellent in barrier properties and impact resistance originally intended in the present invention. The total thickness of the layers of the adhesive resin (b) and a plurality of layers to be used is preferably 5 to 1000 μm, more preferably 10 to 500 μm, and most preferably 20 to 300 μm. If the layer of the adhesive resin (b) is excessively thin, the adhesion properties will get poor, whereas if it is excessively thick, the cost will increase.

While the layer of the high density polyethylene (a) in the present invention includes a recovered scrap layer (r) containing a high density polyethylene as a major component as described above, examples of the layer constitution of the multilayer structure of the present invention containing the layers of the high density polyethylene (a), the layers of the adhesive resin (b) and the layer of the EVOH (c) taking into consideration such a recovered scrap layer (r) are as follows. In these examples, the left is inside and the right is outside. 5 layers: (inside) a/b/c/b/a (outside), a/b/c/b/r, r/b/c/b/a 6 layers: a/b/c/b/r/a, a/r/b/c/b/a, r/a/b/c/b/a, a/r/b/c/b/r, r/a/b/c/b/r, a/b/c/b/a/r, r/b/c/b/r/a, r/b/c/b/a/r 7 layers: a/r/b/c/b/r/a, a/r/b/c/b/a/r, r/a/b/c/b/a/r, r/a/b/c/b/r/a, a/r/b/c/b/r/a, r/a/b/c/b/a/r

It should be noted that the layer structure is not restricted to those listed above. Among these examples, preferable layer structures include a/b/c/b/a, a/b/c/b/r/a, etc.

The overall thickness of the fuel container is preferably 310 to 10000 μm, more preferably 500 to 8500 μm, and most preferably 1000 to 7000 μm. It is noted that the thickness is the average thickness of the fuel container measured at the body thereof. If the overall thickness is excessively thick, the weight will become too large, leading to an adverse effect on fuel consumption of automobiles and also to increase in the cost of the fuel container. On the other hand, if the overall thickness is excessively thin, sufficient stiffness can not be maintained, leading to a problem that a fuel container is easily broken. It therefore is important to determine a thickness according to the capacity and intended use of the fuel container.

In the present invention, it is possible to obtain a greater effect by adjusting the thickness ratio (I/O) to a value smaller than 50/50, wherein I is the total thickness of the layers positioned inside the layer of the ethylene-vinyl alcohol copolymer (c), and O is the total thickness of the layers positioned outside the layer of the ethylene-vinyl alcohol copolymer (c). In other words, the layer of the EVOH (c) is positioned at the inside with respect to the center of the overall thickness. In the case that a layer other than a layer of the (a) and a layer of the (b) is partially contained in the inside or outside of the layer of the ethylene-vinyl alcohol copolymer (c), the thickness of the layer shall be added to I or O. It is noted that the thickness of each layer is the average thickness in the body of the container. The more the EVOH (c) layer is positioned away from the center, the greater the effect is. It is preferable that (I/O)≦45/55, and more preferable that (I/O)≦40/60. In addition, it is particularly preferable that (I/O)≦35/65, and most preferable that (I/O)≦30/70.

As described above, the positioning of the EVOH (c) layer at the inside with respect to the center of the overall thickness can impart the fuel container with excellent barrier properties and excellent impact resistance. This renders the fuel container capable of contributing to solve environmental problems and greatly enhances the safety in practical use of the container. Moreover, because the barrier property against a biodiesel fuel is improved, a barrier property comparable to that of conventional products can be obtained even in use of a layer of the EVOH (c) thinner than before. This leads also to effects of cost reduction and improvement in impact resistance. Moreover, because the impact resistance is improved, impact resistance comparable to that of conventional products is achieved even if the overall thickness of a fuel container is reduced. It therefore becomes possible to achieve reduction in weight of the container and reduction in cost.

In the fuel container of the present invention, while it is preferable that the EVOH (c) layer be positioned in the inside with respect to the center of the overall thickness, it must not be positioned at the innermost layer. While the most general method among the methods for forming fuel containers is extrusion blow molding, a cylindrical molten parison must be cut with a mold and welded in the method. In this process, the cylindrical opening is closed by welding with the innermost layer in contact with itself. Reduction in the adhesion strength of the closed portion (called “pinch-off portion”) will lead to reduction in the impact resistance of the entire fuel container. Therefore, a layer of the high density polyethylene (a) is required to be positioned at the innermost layer. That is, it is preferable that (I/O)≧1/99, more preferable that (I/O)≧2/98, particularly preferable that (I/O)≧5/95, and most preferable that (I/O)≧10/90.

Also, the present invention produces its noticeable effect when the thickness ratio (A/B) satisfies the formula below, wherein A is the thickness of the EVOH layer (c), and B is a total thickness of all the layers:

0.005≦(A/B)≦0.13 (1).

A thickness ratio (A/B) smaller than 0.005 will result in an insufficient gasoline barrier property because the EVOH (c) layer, which is a barrier layer, is thin and some parts where the EVOH (c) layer is extremely thin are formed due to unevenness in thickness of the (c) layer. The value of the ratio (A/B) is preferably 0.01 or more, and more preferably 0.02 or more. On the other hand, if the (A/B) is 0.13 or more, the impact resistance deteriorates as the thickness of the EVOH (c) layer increases. Moreover, in such a case, use of a large amount of an expensive EVOH resin will lead to increase in cost. Therefore, the ratio (A/B) should be 0.10 or less, and preferably 0.07 or less.

The method for producing the fuel container of the present invention made of a multilayer structure is not particularly restricted, and examples thereof include molding methods conducted in the field of general polyolefin, such as extrusion molding, blow molding, and injection molding. In particular, coextrusion molding and coinjection molding are preferred. Among these, coextrusion blow molding is most preferred.

The term “fuel container” referred to in the present invention means fuel containers mounted on automobiles, motor cycles, ships, airplanes, electric generators, and other industrial and agricultural machines, and potable containers for supplying fuels to the fuel containers and also containers for storing fuels to be used for driving such machines.

The fatty acid ester contained in the biodiesel fuel used in the present invention is at least one fatty acid ester selected from the group consisting of fatty acid methyl esters and fatty acid ethyl esters. The fatty acids constituting the esters preferably have 10 to 30 carbon atoms.

Moreover, it is preferable that the biodiesel fuel used in the present invention contains a fatty acid ester in an amount of 1% by weight or more, and more preferably in an amount of 3% by weight or more. By inclusion of bio-derived fatty acid esters in a certain amount or more, the used amount of fossil fuel can be reduced. In this case, the components other than the fatty acid esters are mainly light oil.

From the viewpoint of combustion performance point, it is occasionally preferable that the fuel contain fossil fuel-derived light oil. That is, it may be preferable to use a biodiesel fuel containing both light oil and a fatty acid ester. A preferable upper limit of the content of the fatty acid ester is 80% by weight, and a more preferable upper limit is 60% by weight. In this case, the components other than the fatty acid esters are mainly light oil.

In the present invention, additives may be added to the layers of the high density polyethylene (a), the layers of the adhesive resin (b) and the layer of the EVOH (c), which are constituents of the multilayer structure. Examples of such additives include antioxidants, plasticizers, heat stabilizers, UV light absorbers, antistatic agents, lubricants, colorants and fillers. Specific examples of the additives are as follows.

### Antioxidant:

2,5-di-tert-butylhydroquinone, 2,6-di-tert-butyl-p-cresol, 4,4′-thiobis-(6-tert-butylphenol), 2,2′-methylene-bis-(4-methyl-6-tert-butylphenol), octadecyl-3-(3′,5′-di-tert-butyl-4′-hydroxyphenyl) propionate, 4,4′-thiobis-(6-tert-butylphenol), etc.

### UV Light Absorber:

ethylene-2-cyano-3,3′-diphenyl acrylate, 2-(2′-hydroxy-5′-methylphenyl)benzotriazole, 2-(2′-hydroxy-5′-methylphenyl)benzotriazole, 2-(2′-hydroxy-5′-methylphenyl)benzotriazole, 2-(2′-hydroxy-3′-tert-butyl-5′-methylphenyl)-5-chlorobenzot riazole, 2-hydroxy-4-methoxybenzophenone, 2,2′-dihydroxy-4-methoxybenzophenone, 2-hydroxy-4-methoxybenzophenone, etc.

### Plasticizer:

dimethyl phthalate, diethyl phthalate, dioctyl phthalate, wax, liquid paraffin, phosphates, etc.

### Antistatic Agent:

pentaerythritol monostearate, sorbitan monopalmitate, sulfated polyolefins, polyethylene oxide, carbowax, etc.

### Lubricant:

ethylene bisstearoamide, butyl stearate, etc.

### Colorant:

carbon black, phthalocyanine, quinacridon, indoline, azo pigments, red oxide, etc.

### Filler:

glass fiber, asbestos, ballastonite, calcium silicate, talc, montmorillonite, etc.

It is preferable to add, to the EVOH (c), 0.01 to 1% by weight of one kind or two or more kinds of hydrotalcite compounds, hindered phenol or hindered amine heat stabilizers, metal salts of higher fatty acids (such as calcium stearate and magnesium stearate) as a measure of preventing gel generation.

### EXAMPLES

The present invention is described below with reference to examples and comparative examples. However, the invention is not limited to these examples.

### Example 1

Using an EVOH {ethylene content: 24 mol %, degree of saponification: 99.6%, MI=2.2 g/10 min (at 210° C. under a load of 2160 g) as a core layer, a high density polyethylene (HDPE) (MI=0.01 g/10 min (at 190° C. under a load of 2160 g), 0.96 g/cm³) as outer layers, and an maleic anhydride-modified polyethylene {MI=0.2 g/10 min (at 190° C. under a load of 2160 g), “ADMER GT-6A” produced by Mitsui Chemicals, Inc.) as layers of the adhesive resin (b), a three-kind five-layer laminated material (HDPE/AD/EVOH/AD/HDPE=90/10/20/10/90 μm) was produced by coextrusion molding.

The barrier performance of this laminated material against five kinds of model fuels were measured using a flow-type gas/vapor permeability analyzer (GTR-30×FKE) manufactured by GTR Tech Corporation. The laminated material was conditioned at 20° C. and 65% RH for 1 month and the measurement was conducted at 60° C. The compositions of the five model fuels are as follows.

Ref.C gasoline: toluene/isooctane=50/50 wt %
CE10 gasoline: toluene/isooctane/ethanol=45/45/10 wt %
Diesel fuel A: 100 wt % fatty acid methyl ester derived from rapeseed oil
Diesel fuel B: low-sulfur diesel fuel/diesel fuel A=95/5 wt %
Diesel fuel C: low-sulfur diesel fuel/diesel fuel A=80/20 wt %

Pouches were produced by heat sealing two pieces each taken by cutting the laminated material into a size of 12 cm×12 cm. Into the pouches, 50 cc of each of five kinds of model fuels were filled and were stored in an oxygen atmosphere at 40° C. for one year. In the filling, the air was prevented from entering into the pouches. After the storage, the model fuels were removed and each pouch was bent at an angle of 90°. Based on the condition of cracks in a surface, the brittle fracture resistance was evaluated into five categories (Excellent, Good, Acceptable, Not Acceptable, and Bad). The results are shown in Tables 1 and 2.

### Examples 2 to 4

The fuel barrier test and the brittle fracture resistance test were conducted under the same conditions as those in Example 1, except for changing the thickness and constitute of the individual layers of a multilayer sheet as shown in Table 1. The results are summarized in Tables 1 and 2.

### Comparative Examples 1 and 2

The fuel permeation test and the brittle fracture resistance test were conducted under the same conditions as those in Example 1, except for changing the laminated material to a monolayer sheet of the high density polyethylene (a). The results are summarized in Tables 1 and 2.

TABLE 1

| | | | Permeated amount (g/m² · day) | | | | |
|---|---|---|---|---|---|---|---|
| | EVOH (c) | Thickness | Ref. C | | | | |
| | layer | (a/b/c/b/a) (μm) | gasoline | CE10 gasoline | Diesel fuel A | Diesel fuel B | Diesel fuel C |
| Example 1 | EVOH-A | 90/10/20/10/90 | 0 | 1 | 1 | 1 | 1 |
| Example 2 | EVOH-B | 90/10/20/10/90 | 0 | 3 | 1 | 1 | 1 |
| Example 3 | EVOH-A | 90/10/10/10/90 | 0 | 2 | 1 | 2 | 2 |
| Example 4 | EVOH-B | 90/10/10/10/90 | 0 | 6 | 2 | 3 | 3 |
| Comparative | — | HDPE monolayer | 3100 | 2300 | 3 | 140 | 110 |
| Example 1 | | 200 μm | | | | | |
| Comparative | — | HDPE monolayer | 1600 | 1200 | 2 | 70 | 60 |
| Example 2 | | 400 μm | | | | | |

EVOH-A: ethylene-vinyl alcohol copolymer (ethylene content = 24 mol %)
EVOH-B: ethylene-vinyl alcohol copolymer (ethylene content = 32 mol %)
HDPE (a): The density is 0.970 g/cm³
Adhesive resin (b): “ADMER GT-6A”
Diesel fuel A: Bio-derived fatty acid ester 100 wt %
Diesel fuel B: low-sulfur diesel fuel/bio-derived fatty acid ester = 95/5 wt %
Diesel fuel C: low-sulfur diesel fuel/bio-derived fatty acid ester = 80/20 wt %

TABLE 2

| | | | Brittle fracture resistance | | | | |
|---|---|---|---|---|---|---|---|
| | EVOH (c) | Thickness | Ref. C | | | | |
| | layer | (a/b/c/b/a) (μm) | gasoline | CE10 gasoline | Diesel fuel A | Diesel fuel B | Diesel fuel C |
| Example 1 | EVOH-A | 90/10/20/10/90 | Excellent | Excellent | Excellent | Good | Good |
| Example 2 | EVOH-B | 90/10/20/10/90 | Excellent | Good | Good | Good | Good |
| Example 3 | EVOH-A | 90/10/10/10/90 | Excellent | Good | Good | Good | Good |
| Example 4 | EVOH-B | 90/10/10/10/90 | Excellent | Good | Good | Good | Good |
| Comparative | — | HDPE monolayer | Good | Acceptable | Not acceptable | Bad | Bad |
| Example 1 | | 200 μm | | | | | |
| Comparative | — | HDPE monolayer | Good | Acceptable | Not acceptable | Bad | Bad |
| Example 2 | | 400 μm | | | | | |

EVOH-A: ethylene-vinyl alcohol copolymer (ethylene content = 24 mol %)
EVOH-B: ethylene-vinyl alcohol copolymer (ethylene content = 32 mol %)
HDPE (a): The density is 0.970 g/cm³
Adhesive resin (b): “ADMER GT-6A”
Diesel fuel A: Bio-derived fatty acid ester 100 wt %
Diesel fuel B: low-sulfur diesel fuel/bio-derived fatty acid ester = 95/5 wt %
Diesel fuel C: low-sulfur diesel fuel/bio-derived fatty acid ester = 80/20 wt %
Brittle fracture resistance: Excellent > Good > Acceptable > Not acceptable > Bad

1. A fuel container comprising a multilayer structure wherein layers of high density polyethylene (a) are located on both sides of a layer of an ethylene-vinyl alcohol copolymer (c) via layers of adhesive resin (b), and a biodiesel fuel comprising at least one fatty acid ester selected from the group consisting of fatty acid methyl ester and fatty acid ethyl ester is contained therein.

2. The fuel container according to claim 1, wherein the ethylene-vinyl alcohol copolymer (c) has an ethylene content of 20 to 60 mol %.

3. The fuel container according to claim 1, wherein the ethylene-vinyl alcohol copolymer (c) has an ethylene content of 22 to 30 mol %.

4. The fuel container according to claim 1, wherein the biodiesel fuel contains 1% by weight or more of the fatty acid ester.

5. The fuel container according to claim 1, wherein the thickness ratio (I/O) is smaller than 50/50, where I is the total thickness of the layers positioned inside the layer of the ethylene-vinyl alcohol copolymer (c), and O is the total thickness of the layers positioned outside the layer of the ethylene-vinyl alcohol copolymer (c), and the thickness ratio (A/B) satisfies the following formula (1):
0.005≦(A/B)≦0.13 (1)
where A is the thickness of the layer of ethylene-vinyl alcohol copolymer (c) and B is the total thickness of all layers.
